(19) United States
(12) Patent Application Publication
(10) Pub. No.: US 2014/0096063 A1
(43) Pub. Date: Apr. 3, 2014

(54) INFORMATION DISPLAY DEVICE, INFORMATION DISPLAY METHOD, AND COMPUTER PROGRAM PRODUCT

(71) Applicant: Kabushiki Kaisha Toshiba, Tokyo (JP)

(72) Inventor: Jun Kano, Ome-shi (JP)

(21) Appl. No.: 13/907,398

(22) Filed: May 31, 2013

(30) Foreign Application Priority Data
Sep. 28, 2012 (JP) 2012-217252

(51) Int. Cl. G06F 3/0484

(52) U.S. Cl. CPC G06F 3/0484
USPC 715/778

(57) ABSTRACT

According to one embodiment, an information display device includes a display, a content acquisition module, an overlay module, and a display controller. The display is configured to perform displaying. The content acquisition module is configured to acquire a multiple-screen content configured by contents capable of being displayed individually on a plurality of screens, respectively. The overlay module is configured to arrange each of the contents constituting the multiple-screen content at different positions, and to overlay the contents with each other to generate a single overlaid content. The display controller is configured to cause the display to display the overlaid content.

### CROSS-REFERENCE TO RELATED APPLICATIONS

This application is based upon and claims the benefit of priority from Japanese Patent Application No. 2012-217252, filed Sep. 28, 2012, the entire contents of which are incorporated herein by reference.

### FIELD

Embodiments described herein relate generally to an information display device, an information display method, and a computer program product.

### BACKGROUND

Conventionally, according to a broadcast receiver that receives television broadcast signals, image data and data for data broadcast contained in the television broadcast signals are displayed within a single screen.

Furthermore, recently, there have been considered a service that provides a content linked with a broadcasting over a network, such as the Internet, which represents a move toward amalgamation of broadcasting and communication. With such service, attempts are being made to provide content having a dual-screen configuration. An exemplary attempt is to provide portable information terminals, such as the tablet terminals or the smartphones, with content for network distribution, while providing television and other broadcast receivers with broadcast content.

Displaying the content having the dual-screen configuration, however, requires two devices (or two screens) of the broadcast receiver and the portable information terminal. Thus, a device that has both a broadcast receiving function and a network communication function, but has only a single screen, can only be used for either one of the broadcast content or the network distribution content.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary diagram of a configuration example of an information display system according to an embodiment;

FIG. 2A is an exemplary diagram of a displaying example of a single-screen content in the embodiment;

FIG. 2B is an exemplary diagram of a displaying example of the single-screen content in the embodiment;

FIG. 3A is an exemplary diagram of a displaying example of a dual-screen content in the embodiment;

FIG. 3B is an exemplary diagram of a displaying example of the dual-screen content in the embodiment;

FIG. 4 is an exemplary diagram of a hardware configuration example of a tablet terminal of FIG. 1 in the embodiment;

FIG. 5 is an exemplary diagram of a functional configuration example of the tablet terminal of FIG. 1 in the embodiment;

FIG. 6A is an exemplary diagram for explaining a change in an orientation of the tablet terminal in the embodiment;

FIG. 6B is an exemplary diagram for explaining the change in the orientation of the tablet terminal in the embodiment;

FIG. 7A is an exemplary diagram for explaining an example of a overlaid content generated by an image overlaying module of FIG. 5 in the embodiment;

FIG. 7B is an exemplary diagram for explaining an example of the overlaid content generated by the image overlaying module of FIG. 5 in the embodiment;

FIG. 7C is an exemplary diagram for explaining an example of the overlaid content generated by the image overlaying module of FIG. 5 in the embodiment;

FIG. 8A is an exemplary diagram of one example of the single-screen content displayed on the tablet terminal in the embodiment;

FIG. 8B is an exemplary diagram of one example of the dual-screen content (overlaid content) displayed on the tablet terminal in the embodiment; and

FIG. 9 is an exemplary flowchart of a content display process performed by a tablet terminal 20 in the embodiment.

### DETAILED DESCRIPTION

In general, according to one embodiment, an information display device comprises a display, a content acquisition module, an overlay module, and a display controller. The display is configured to perform displaying. The content acquisition module is configured to acquire a multiple-screen content configured by contents capable of being displayed individually on a plurality of screens, respectively. The overlay module is configured to arrange each of the contents constituting the multiple-screen content at different positions, and to overlay the contents with each other to generate a single overlaid content. The display controller is configured to cause the display to display the overlaid content.

An information display device, an information display method, and a computer program according to one embodiment will be described in detail below with reference to the accompanying drawings. The embodiment to be described hereunder represents an exemplary application to an information display system that comprises a content provider and a tablet terminal as an information display device.

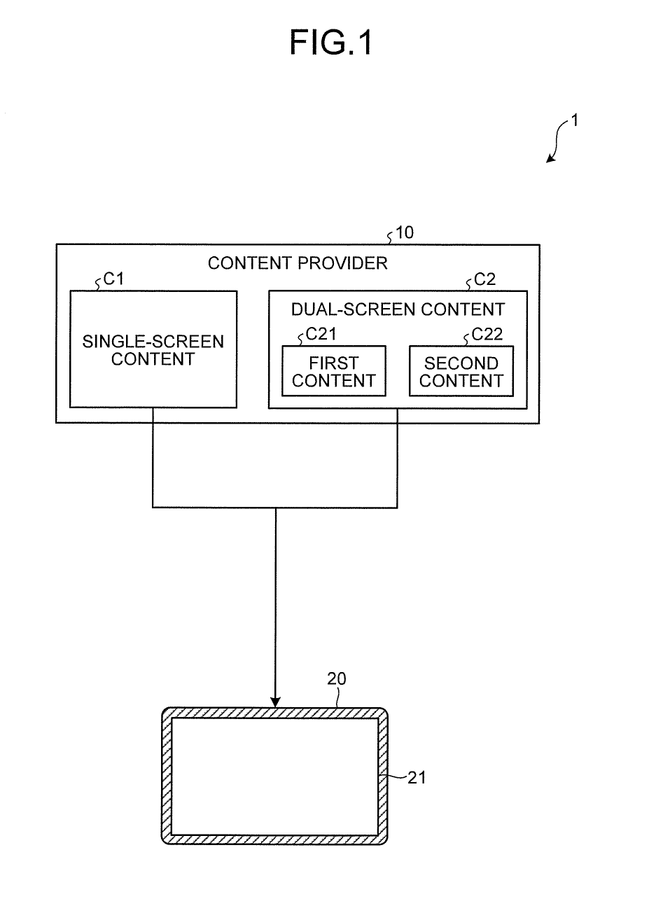

FIG. 1 is a configuration diagram illustrating the information display system according to the embodiment. As illustrated in FIG. 1, an information display system 1 comprises a content provider 10 and a tablet terminal 20.

The content provider 10 provides the information display device, such as the tablet terminal 20, with displayable content. Specifically, the content provider 10 provides a single-screen content C1 and a dual-screen content C2 as the content to be provided.

The single-screen content C1 is generated so as to be displayed on a single screen. The single-screen content C1 is, for example, video data (moving image data) provided in the digital broadcasting.

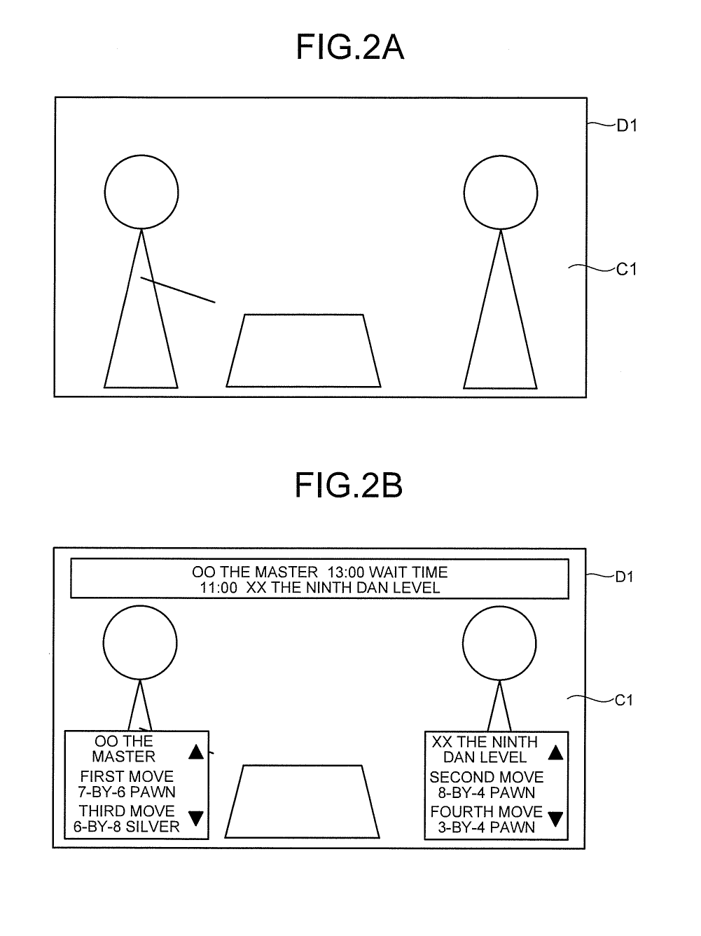

FIGS. 2A and 2B illustrate displays of the single-screen content C1. As illustrated in FIG. 2A, according to a device (e.g. a television or other broadcast receiver) that receives the single-screen content C1, video data provided as the single-screen content C1 is displayed in one display screen D1 of the device. FIG. 2A illustrates the horizontally long video data that represents a game of SHOGI (Japanese chess). If additional information is provided together with the video data as the single-screen content C1, the additional information is superimposed on the video data when displayed within the display screen D1, as illustrated in FIG. 2B.

The dual-screen content C2 is a number of contents (a group of contents) generated so as to be displayed on two display screens. The dual-screen content C2 comprises first content C21 and second content C22 displayed individually on the respective display screens. It is here noted that the first content C21 is, for example, video data (moving image data) to be provided by digital broadcasting. Further, the second content C22 is content, such as images and characters, associated with the video data of the first content C21.

The first content C21 and the second content C22 may be configured to be provided individually or simultaneously. Specifically, while the first content C21 is provided by, for example, being superimposed on the broadcast signal, the second content C22 may be provided by being superimposed on the broadcast signal or provided over the network from a server. If the second content C22 is to be provided over the network, information on addresses from which the first content C21 and the second content C22 are acquired are superimposed on the broadcast signal.

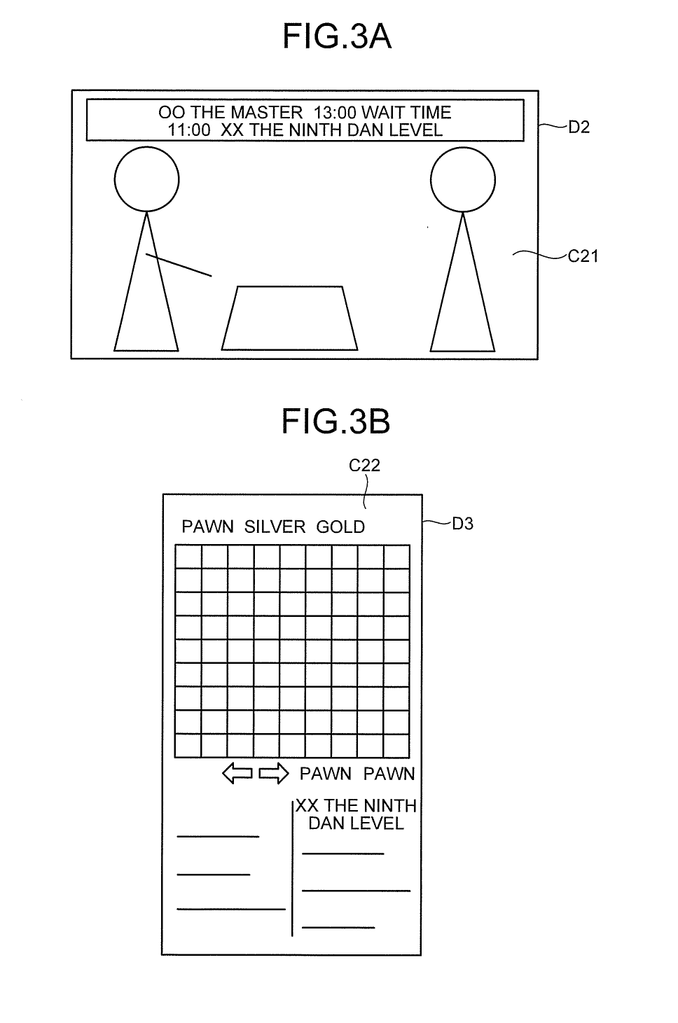

FIGS. 3A and 3B are views illustrating a displaying example of the dual-screen content C2. As illustrated in FIG. 3A, the device (e.g. a television or other broadcast receiver) having a main display screen D2 out of the two display screens displays the horizontally long video data (that represents the game of SHOGI) provided as the first content C21. It is noted that FIG. 3A illustrates a displaying example of the video data and the additional information provided as the first content C21.

As illustrated in FIG. 3B, the device (e.g. a portable terminal) having a subsidiary display screen D3 out of the two display screens displays associated information (vertically long image data) relating to the video data of the first content C21. Here, the associated information is provided as the second content C22. It is noted that the second content C22 represents an image of the SHOGI-game situation having contents constantly updated according as the game progresses.

In comparison to the additional information explained with reference to FIG. 2B, the second content C22 may be laid out within an entire display area of the display screen D3 or an entire display area within an application window displayed on the display screen D3. Similarly, the first content C21 may be laid out within an entire screen of the display screen D3 or the entire display area within an application window displayed on the display screen D3. Specifically, the first content C21 and the second content C22 are capable of being displayed individually on respective screens. Furthermore, the first content C21 and the second content C22 may be contents to be distributed and displayed on different screens.

Here, a single device may have both the display screen D2 and the display screen D3, or different devices may have the display screen D2 and the display screen D3, respectively. If different devices have the display screen D2 and the display screen D3, respectively, the two devices may be operatively associated with each other in order to acquire the dual-screen content C2.

A method for providing the single-screen content C1 and the dual-screen content C2 is not specifically limited, and the single-screen content C1 and the dual-screen content C2 may be provided using a digital broadcast signal or via a communication line, such as the Internet. In addition, the first content C21 and the second content C22 of the dual-screen content C2 may be provided by an identical method or different methods. For example, the first content C21 may be provided using the digital broadcast signal, while the second content C22 may be provided via the communication line, such as the Internet. Furthermore, the first content C21 and the second content C22 may be the same with respect to each other or different from each other.

The content provider 10 may be configured as a single device having a broadcast function for transmitting the digital broadcast signal and a server function for providing content via the Internet. Furthermore, the content provider 10 may be configured by a group of devices each having a corresponding broadcast or server function.

As mentioned earlier, displaying of the dual-screen content C2 requires two devices (or two display screens). Therefore, a device capable of receiving the dual-screen content C2, but has only one display screen, can only display either one of the first content C21 and the second content C22.

The tablet terminal 20 in the embodiment therefore overlays the first content C21 and the second content C22 that constitute the dual-screen content C2 with each other, as will be described later, to thereby generate a single overlaid content C3 that can be displayed on a single screen. By displaying the overlaid content C3, the second content C22 can practically be displayed within a single screen. The tablet terminal 20 will be described below.

As illustrated in FIG. 1, the tablet terminal 20 is a portable information display device comprising a display 21. The tablet terminal 20 displays various types of information, such as the single-screen content C1 and the dual-screen content C2, on the display 21.

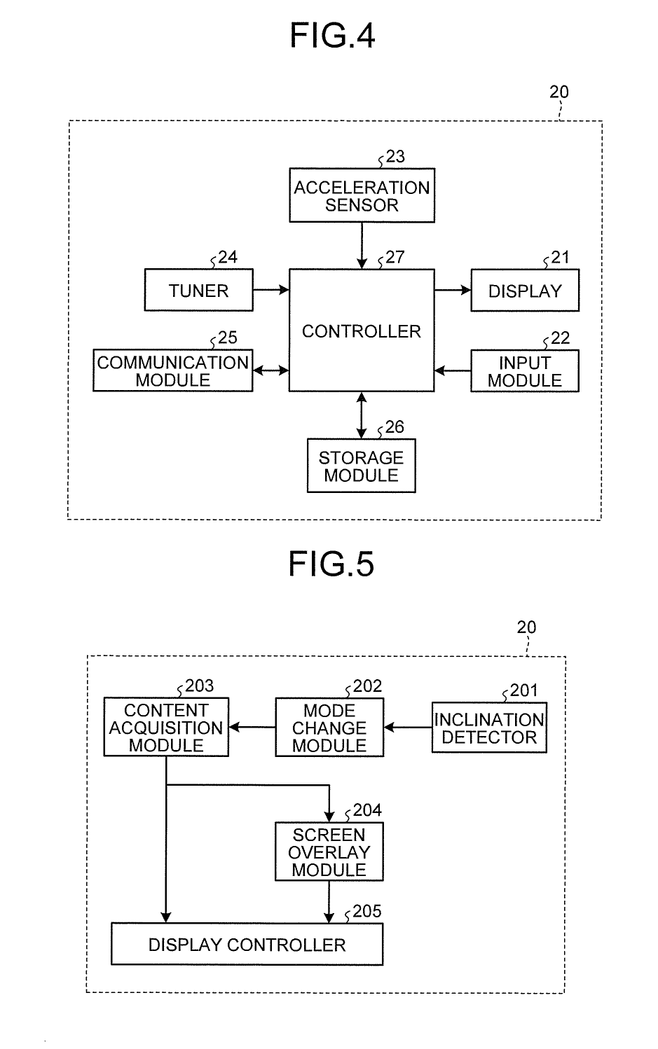

FIG. 4 illustrates a hardware configuration example of the tablet terminal 20. As illustrated in FIG. 4, the tablet terminal 20 comprises the display 21, an input module 22, a tuner 24, a communication module 25, a storage module 26, and a controller 27. The tablet terminal 20 further comprises, for example, a speaker, though not illustrated.

The display 21 is a display device, such as a liquid crystal display (LCD) and an organic electro luminescence (EL). The display 21 displays various types of information under the control of the controller 27.

The input module 22 is an input device such as a pointing device and/or buttons for receiving instructions and/or inputs from a user. In the embodiment, a light-transmissive touch panel that is superimposed on an entire area of a display surface of the display 21 or that is superimposed on a portion of the display surface is used as the pointing device; however, the present invention is not limited thereto.

An acceleration sensor 23 is a sensing device that senses acceleration applied to the tablet terminal 20. For example, the acceleration sensor 23 outputs a change in an orientation (inclination or rotation) of the tablet terminal 20 in directions of three axes, as a sensing result.

The tuner 24 receives a digital broadcast signal transmitted from, for example, the content provider 10 via an antenna not illustrated. When a specific channel is specified by the user through a channel selection operation, the tuner 24 receives the broadcast signal of the specific channel under the control of the controller 27.

The communication module 25 is a communication interface that can be connected to the network (not illustrated), such as the Internet. The communication module 25 transmits and receives various types of information to and from an external device (e.g. the content provider 10) connected to the network, under the control of the controller 27.

The storage module 26 comprises a nonvolatile storage medium, such as a read-only memory (ROM), a hard disk drive (HDD), and a solid state drive (SSD). The storage module 26 stores therein, for example, various programs and setting information.

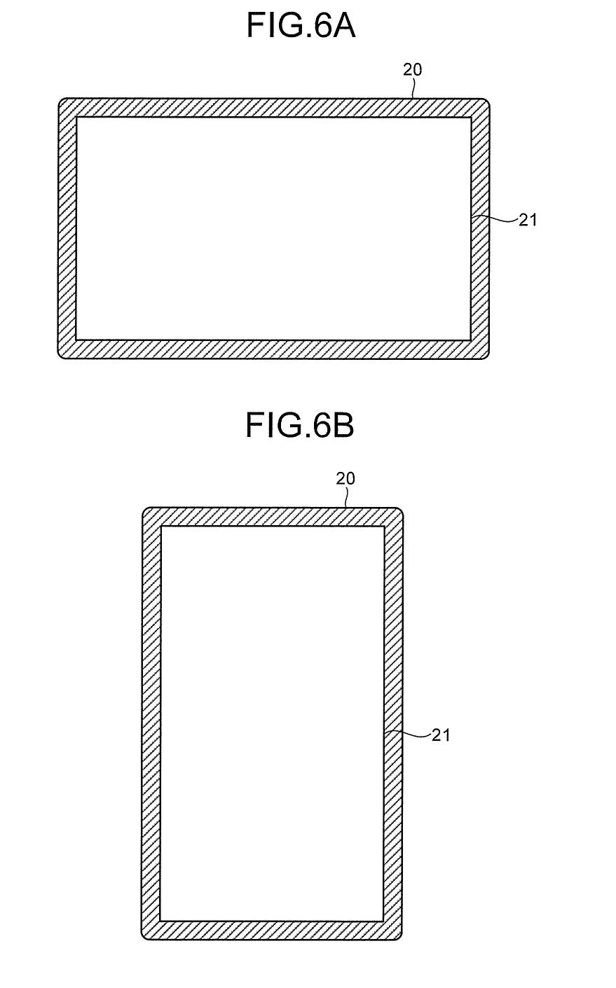

The controller 27 comprises a central processing unit (CPU) and a random access memory (RAM) (none of these are illustrated). The controller 27 cooperates with a program stored in the storage module 26 in integrally controlling the operation of the tablet terminal 20. In addition, the controller 27 cooperates with the program stored in the storage module 26 in achieving functional modules (see FIG. 5) relating to acquisition and display of the contents.

A functional configuration of the tablet terminal 20 will be described below with reference to FIG. 5. FIG. 5 illustrates a functional configuration example of the tablet terminal 20.

As illustrated in FIG. 5, the controller 27 of the tablet terminal 20 cooperates with the program stored in the storage module 26 in achieving, as functional modules of the tablet terminal 20, an inclination detector 201, a mode change module 202, a content acquisition module 203, a screen overlay module 204, and a display controller 205.

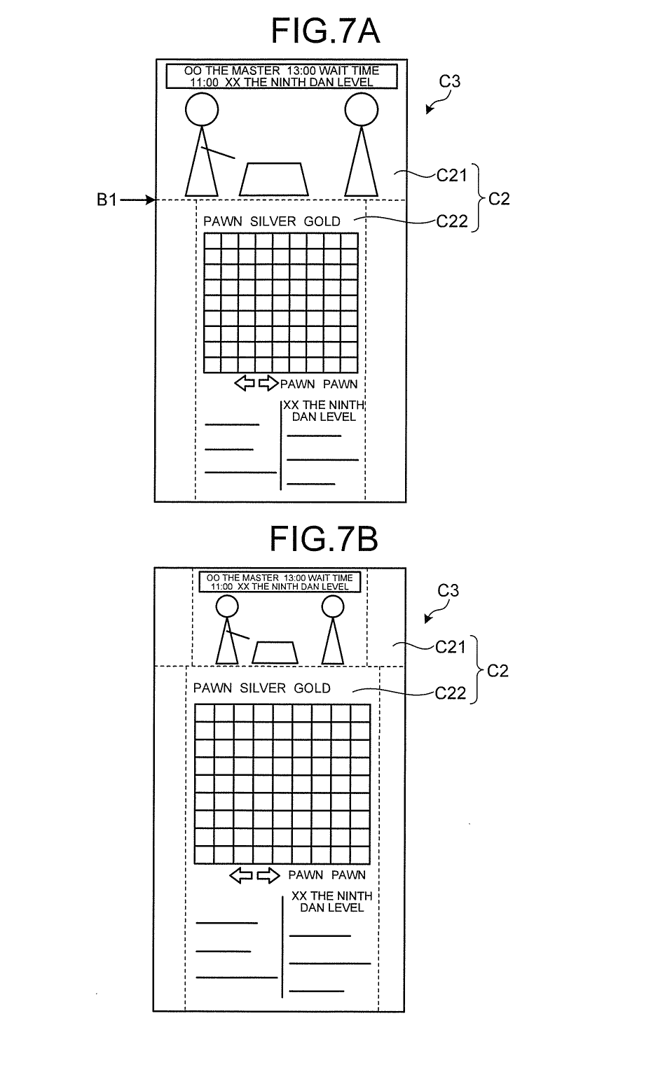

The inclination detector 201 detects that the orientation of the tablet terminal 20 is put into a predetermined condition based on the sensing result of the acceleration sensor 23. Specifically, the inclination detector 201 detects that a long side of a screen of the display 21 is changed into a horizontal orientation (see FIG. 6A) or a vertical orientation (see FIG. 6B) relative to a user who holds the tablet terminal 20. It is noted that FIGS. 6A and 6B are diagrams illustrating a change in the orientation of the tablet terminal 20.

The mode change module 202 changes an operation mode of the content acquisition module 203 to a single-screen mode or a dual-screen mode according to a detection result of the inclination detector 201. Specifically, if the inclination detector 201 detects that the long side of the screen of the display 21 has changed to the horizontal orientation, the mode change module 202 changes the operation mode of the content acquisition module 203 to the single-screen mode in which the single-screen content C1 is to be acquired. Similarly, if the inclination detector 201 detects that the long side of the screen of the display 21 has changed to the vertical orientation, the mode change module 202 changes the operation mode of the content acquisition module 203 to the dual-screen mode in which the dual-screen content C2 is to be acquired.

The content acquisition module 203 acquires content provided by the content provider 10 using the tuner 24 or the communication module 25 according to instructions given by a user via the input module 22. The content acquisition module 203 changes the content to be acquired between the single-screen content C1 and the dual-screen content C2 according to the change of the operation mode by the mode change module 202. Specifically, the content acquisition module 203 acquires the single-screen content C1 from the content provider 10 in the single-screen mode. Similarly, the content acquisition module 203 acquires the dual-screen content C2 from the content provider 10 in the dual-screen mode.

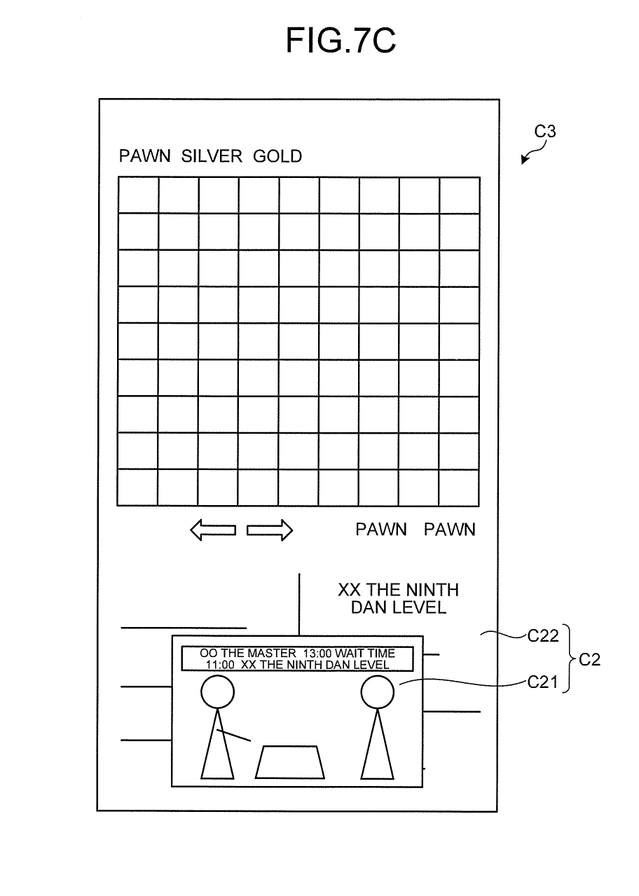

The screen overlay module 204 overlays the first content C21 and the second content C22 that are contained in the dual-screen content C2 acquired by the content acquisition module 203 with each other to thereby generate the overlaid content C3 that represents the first content C21 and the second content C22 placed within a single screen. It is noted that, in the overlay content, the first content C21 and the second content C22 may be placed in areas different from each other within the display screen so that the first content C21 is not placed on top of the second content C22, or vice versa. Specifically, in this case, the screen overlay module 204 generates an overlaid content that comprises a video content (moving image) of a digital broadcast program and a content associated with the program placed at positions different from each other. Exemplary content generated by the screen overlay module 204 will be described below with reference to FIGS. 7A, 7B, and 7C.

As illustrated in FIG. 7A, for example, the screen overlay module 204 generates the overlaid content C3 in which the first content C21 is placed in an upper portion of the screen and the second content C22 is placed below the first content C21. A screen ratio (screen occupancy) of the first content C21 and the second content C22 within the screen is not specifically limited. For example, a first content (e.g. the first content C21) may be placed so as to be maximized in the horizontal direction of the screen, and a second content is placed in the remaining area while maintaining an aspect ratio thereof.

The screen ratios of the first content C21 and the second content C22 are not fixed by any values. Specifically, if an operation to change the screen ratio is received from the user via the input module 22 while the overlaid content C3 is displayed on the display 21 by the display controller 205 to be described later, the screen overlay module 204 generates the overlaid content C3 with the screen ratio in accordance with the operation.

For example, if a pinch operation for enlarging the second content C22 (or to shrink the first content C21 through the pinch operation) is performed on the screen illustrated in FIG. 7A, the screen overlay module 204 overlays the content in accordance with the specific operation performed (an amount of enlargement of the second content C22 or an amount of shrinkage of the first content C21), thereby generating the overlaid content C3 that contains the second content C22 with an enlarged screen ratio as illustrated in FIG. 7B.

The above-described example is not the only possible method for changing the screen ratio, and alternatively, other methods may be used. For example, a boundary B1 between the first content C21 and the second content C22 may be slid up or down vertically, or four corners of the first content C21 or the second content C22 may be dragged in an enlarging or shrinking direction.

A layout of the overlaid content C3 (the first content C21 and the second content C22) is not limited only to those illustrated in the examples of FIG. 7. In particular, according to FIGS. 7A and 7B, the content is overlaid while independence of each of the first content C21 and the second content C22 is maintained. However, as illustrated in FIG. 7C, the overlaid content C3 may be generated through, for example, a picture-in-picture mode in which the first content C21 is placed over the second content C22.

As illustrated in FIG. 5, the display controller 205 is a functional module that performs display controlling of the display 21, and causes the display 21 to display information such as the content acquired by the content acquisition module 203. Specifically, the display controller 205 causes the display 21 to display the single-screen content C1 acquired by the content acquisition module 203. In addition, the display controller 205 causes the display 21 to display the overlaid content 03 generated by the screen overlay module 204.

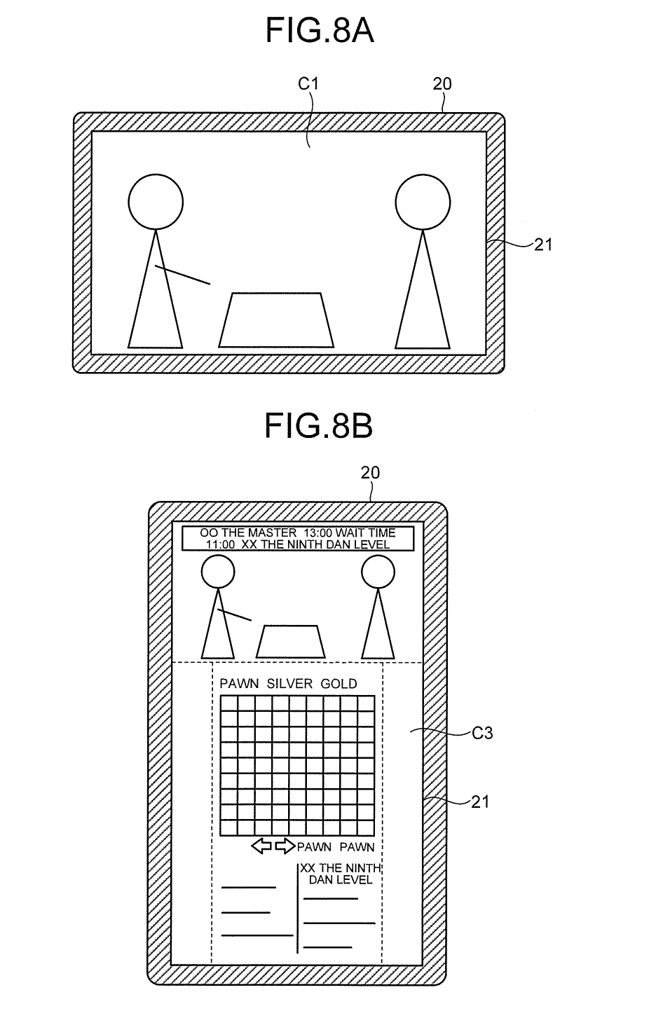

Through the controlling performed by each of the functional modules described above, when the long side of the screen of the tablet terminal 20 (the display 21) is changed to the horizontal orientation, the horizontally long single-screen content C1 is displayed as illustrated in FIG. 8A. Further, when the long side of the screen of the tablet terminal 20 (the display 21) is changed to the vertical orientation, the overlaid content C3 (the dual-screen content C2) is displayed as illustrated in FIG. 8B.

As described heretofore, the tablet terminal 20 of the embodiment performs a controlling so as to display the horizontally long single-screen content C1 when the long side of the screen of the tablet terminal 20 (the display 21) is changed to the horizontal orientation, based on the aspect ratio of the single-screen content C1 acquired by the content acquisition module 203 and the aspect ratio of the display screen of the display 21. Consequently, the single-screen content C1 can be displayed with a maximized display size, thereby enhancing visibility of the single-screen content C1.

In the embodiment, the aspect ratio of the single-screen content C1 is used as a basis for determining the operation mode; however, the present embodiment is not limited thereto. That is, the aspect ratio of the dual-screen content C2, i.e., the aspect ratio of either one or both of the first content C21 and the second content C22 may be used as a basis for determining the operation mode.

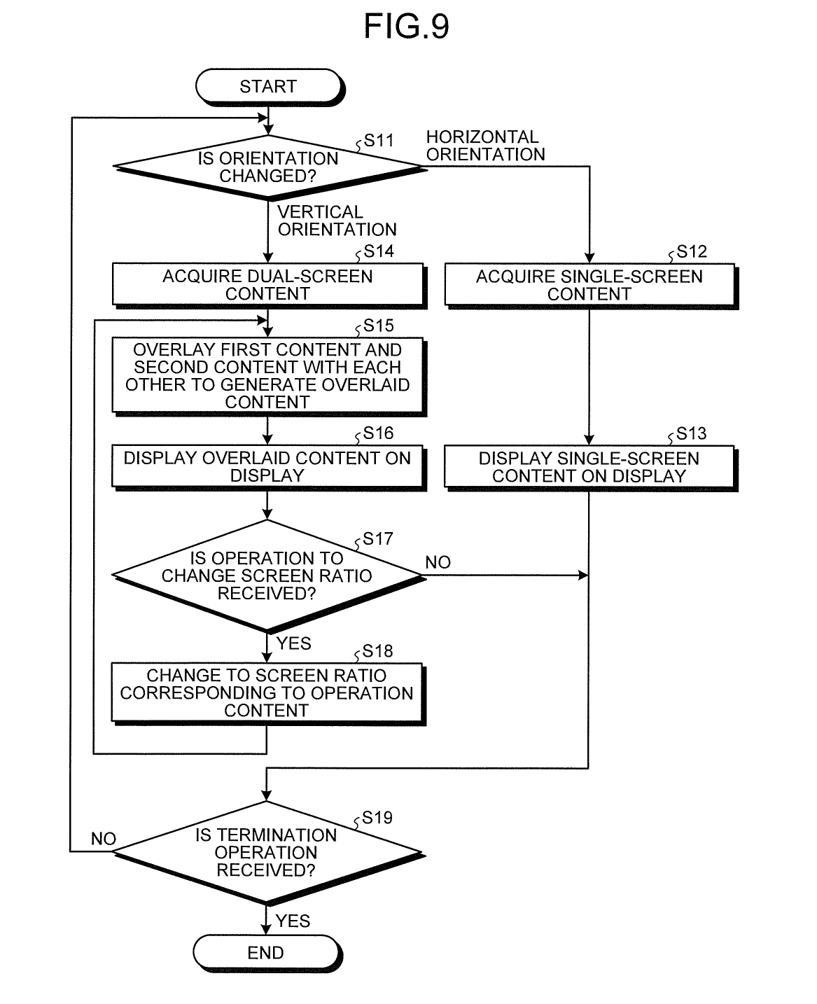

The operation of the tablet terminal 20 will be described below with reference to FIG. 9. FIG. 9 illustrates an exemplary flowchart illustrating a content display process performed by the tablet terminal 20. The content display process assumes that the single-screen content C1 or the dual-screen content C2 has been acquired by the content acquisition module 203.

The inclination detector 201 first determines, based on the sensing result of the acceleration sensor 23, whether the orientation of the tablet terminal 20 is changed (S11). If the long side of the screen of the tablet terminal 20 is here detected to be changed to the horizontal orientation (horizontal orientation at S11), the mode change module 202 changes the operation mode to the single-screen mode to thereby cause the content acquisition module 203 to acquire the single-screen content C1 (S12). Then, the display controller 205 causes the display 21 to display the single-screen content C1 acquired at S12 (S13), and the process proceeds to S19. Here, it is explained that the single-screen content C1 such as the broadcast video is displayed in the single-screen mode. However, information associated with the broadcast video such as the second content C22 of the dual-screen content C2 may be displayed in the single-screen mode.

If, in contrast, the long side of the screen of the tablet terminal 20 is detected to be changed to the vertical orientation (vertical orientation at S11), the mode change module 202 changes the operation mode to the dual-screen mode to thereby cause the content acquisition module 203 to acquire the dual-screen content C2 (S14). Then, the display controller 205 overlays the first content C21 and the second content C22 that constitute the dual-screen content C2 acquired at S14 with each other to thereby generate the overlaid content C3 that can be displayed within a single screen (S15). The display controller 205 then displays the overlaid content C3 generated at S15 on the display 21 (S16).

Next, the screen overlay module 204 determines whether an operation to change the screen ratio of the first content C21 and the second content C22 is received via the input module 22 (S17). If the operation to change the screen ratio is received (Yes at S17), the screen overlay module 204 changes the screen ratio to a ratio corresponding to the operation content (S18). Returning to S15, the screen overlay module 204 generates the overlaid content C3 in which the new screen ratio is incorporated. If the operation to change the screen ratio is not received (No at S17), the process proceeds to S19.

At subsequent S19, the content acquisition module 203 determines whether an operation to terminate acquisition (viewing) of content is input via the input module 22. If the termination operation is not yet input (No at S19), the process returns to S11 and continues with acquisition (viewing) of the content. If an input of the terminating operation is received (Yes at S19), the content acquisition module 203 terminates the acquisition of content, thereby terminating the process.

As described heretofore, in the embodiment, the single overlaid content C3 that can be displayed on a single screen is generated from the first content C21 and the second content C22 that constitute the dual-screen content C2, and the overlaid content C3 is displayed. This practically enables the second content C22 to be displayed within a single screen, so that the convenience associated with the displaying of the dual-screen content C2 can be enhanced.

In addition, acquisition of the single-screen content C1 or the dual-screen content C2 is switched therebetween in accordance with the orientation of the tablet terminal. Accordingly, a user is allowed to display content suitable for the orientation of the display screen when the display 21 is viewed. This permits display in consideration of visibility of the single-screen content C1 and the dual-screen content C2.

While certain embodiments have been described, these embodiments have been presented by way of example only, and are not intended to limit the scope of the present invention. Indeed, the novel methods and systems described herein may be embodied in a variety of other forms; furthermore, various omissions, substitutions, and changes in the form of the methods and systems described herein may be made without departing from the spirit of the invention. The accompanying claims and their equivalents are intended to cover such forms or modifications as would fall within the scope and spirit of the invention.

For example, in the above-described embodiment, the single-screen mode is set when the long side of the screen of the tablet terminal 20 is changed to the horizontal orientation and the dual-screen mode is set when the long side of the screen of the tablet terminal 20 is changed to the vertical orientation; however, the present embodiment is not limited thereto. In particular, the above changeover of the operation mode can be configured to be opposite for a case when the single-screen content C1 is generated in the vertically long orientation. In this case, the mode change module 202 may determine the aspect ratio of the single-screen content C1 (or the dual-screen content C2) received by the tuner 24 or the communication module 25 and, based on the result of this determination, the newly selected operation mode is automatically set.

In the above-described embodiment, the content to be acquired is changed between the single-screen content C1 and the dual-screen content 02 depending on the change in the orientation of the tablet terminal; however, the present embodiment is not limited thereto. In particular, either one of the single-screen content C1 or the dual-screen content C2 can be acquired in accordance with an instruction of a user, and not in accordance with the orientation of the tablet terminal. If this approach is taken, the single-screen content C1 or the dual-screen content C2 can be acquired at any time through the procedure performed by the mode change module 202 to change the operation mode to that for the content that is specified by the user to acquire (view).

The above embodiment has been described for an example of displaying the dual-screen content C2 comprising contents to be displayed individually on two respective display screens; however, the present invention is not limited thereto. In particular, instead of the dual-screen content C2, a multiple-screen content configured by contents which are to be individually displayed on a plurality of screens can be used. Also in this case, through the same control as described above, a single overlaid content C3 is generated by overlaying the contents for different screens with each other, so that the overlaid content C3 is to be displayed on the display 21.

In the above embodiment, the information display device according to the embodiment is applied to the tablet terminal 20; however, the present embodiment is not limited thereto. In particular, the information display device according to the embodiment may be applied to other types of information display devices, such as a portable phone and a smartphone.

In the above embodiment, the program to be executed by the tablet terminal 20 is configured to be retained in the storage module 26 of the tablet terminal 20. The program may, instead, be configured so as to be provided by being recorded on a computer-readable recording medium, such as a CD-ROM, a flexible disk (FD), a CD-R, and a digital versatile disk (DVD), in an installable format or an executable format.

The program to be executed by the tablet terminal 20 of the embodiment may also be configured so as to be stored in a computer connected to a network such as the Internet and to be downloaded over the network. The program to be executed by the tablet terminal 20 of the embodiment may still be configured so as to be provided or distributed over a network such as the Internet.

Moreover, the various modules of the systems described herein can be implemented as software applications, hardware and/or software modules, or components on one or more computers, such as servers. While the various modules are illustrated separately, they may share some or all of the same underlying logic or code.

What is claimed is:

1. An information display device comprising:
a display configured to perform displaying;
a content acquisition module configured to acquire a multiple-screen content configured by contents capable of being displayed individually on a plurality of screens, respectively;
an overlay module configured to arrange each of the contents constituting the multiple-screen content at different positions, and to overlay the contents with each other to generate a single overlaid content; and
a display controller configured to cause the display to display the overlaid content.

2. The information display device of claim 1, wherein
the content acquisition module is configured to selectively acquire the multiple-screen content or a single-screen content to be displayed on a single screen, and,
if the single-screen content is acquired, the display controller causes the display to display the single-screen content.

3. The information display device of claim 2, further comprising:
a detector configured to detect an orientation of the information display device; and
a change module configured to change an operation mode of the content acquisition module so that the content acquisition module acquires the multiple-screen content or the single-screen content in accordance with the orientation detected by the detector.

4. The information display device of claim 3, wherein the detector is configured to detect a change in an orientation of the display relative to a user who operates the information display device, as the orientation of the information display device.

5. The information display device of claim 4, wherein the change module is configured to change the operation mode of the content acquisition module based on an aspect ratio of the single-screen content or the multiple-screen content acquired by the content acquisition module and an aspect ratio of a display screen of the display.

6. The information display device of claim 1, further comprising:
a receiver configured to receive an operation to change a screen ratio corresponding to displaying of the contents, wherein
the overlay module is configured to overlay the contents with each other at the screen ratio associated with the operation received by the receiver.

7. An information display method performed by an information display device comprising a display configured to perform displaying, the information display method comprising:
acquiring a multiple-screen content configured by contents capable of being displayed individually on a plurality of screens, respectively;
arranging each of the contents constituting the multiple-screen content at different positions, and overlaying the contents with each other, to generate a single overlaid content; and
causing the display to display the overlaid content.

8. A computer program product having a non-transitory computer readable medium including programmed instructions, wherein the instructions, when executed by a computer of an information display device comprising a display configured to perform displaying, cause the computer to perform:
acquiring a multiple-screen content configured by contents capable of being displayed individually on a plurality of screens, respectively;
arranging each of the contents constituting the multiple-screen content at different positions, and overlaying the contents with each other, to generate a single overlaid content; and
causing the display to display the overlaid content.
